(19) United States
(12) Patent Application Publication
(10) Pub. No.: US 2006/0248718 A1
(43) Pub. Date: Nov. 9, 2006

(54) Superalloy repair methods and inserts

(75) Inventors: Edward R. Szela, West Springfield, MA (US); James T. Beals, West Hartford, CT (US); Joshua E. Persky, Manchester, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/123,772

(22) Filed: May 6, 2005

(51) Int. Cl. B23P 6/00; B23P 15/02; B21K 3/04

(52) U.S. Cl. 29/889.1; 29/889.7; 29/402.13

(57) ABSTRACT

A method for forming or remanufacturing a component to have an internal space. A refractory metal blocking element is positioned with at least a portion to be within the internal space. A material is added by at least one of laser cladding and diffusion brazing, the blocking element at least partially blocking entry of the material to the internal space. The blocking element is removed.

### BACKGROUND OF THE INVENTION

The invention relates to the manufacture, remanufacture, and restoration of nickel- or cobalt-based superalloy parts. More particularly, the invention relates to the restoration and/or remanufacture of defective, worn, and/or damaged gas turbine engine components including turbine and compressor blades and vanes, blade outer air seals, and transition duct segments.

The components of gas turbine engines are subject to wear and damage. Even moderate wear and damage of certain components may interfere with optimal operation of the engine. Particular areas of concern involve parts which interact with the gas path such as seals and the airfoils of various blades and vanes. Wear and damage may interfere with their aerodynamic efficiency, produce dynamic force imbalances, and even structurally compromise the worn/damaged parts in more extreme cases.

Various techniques have been proposed for more extensive restoration of worn or damaged parts of gas turbine engines. U.S. Pat. No. 4,822,248 discloses use of a plasma torch to deposit nickel- or cobalt-based superalloy material. U.S. Pat. No. 5,732,467 identifies the use of high velocity oxy-fuel (HVOF) and low pressure plasma spray (LPPS) techniques for repairing cracks in such turbine elements. U.S. Pat. No. 5,783,318 also identifies LPPS techniques in addition to laser welding and plasma transferred arc welding. U.S. Pat. No. 6,049,978 identifies further use of HVOF techniques. Such techniques have offered a limited ability to build up replacement material to restore an original or near original cross-section. However, the structural properties of the replacement material may be substantially limited relative to those of the base material. U.S. Pat. Nos. 4,008,844 and 6,503,349 disclose methods and repair materials for transient liquid phase diffusion brazing repairs. Such a repair material is available under the trademark TURBOFIX.

Cracks tend to be rather narrow (e.g., 0.25 mm or less), but can be much wider depending upon engine exposure and oxidation. For thin cracks, it may be advantageous to form a diffusion bond crack repair (i.e., without machining out the crack to broaden the crack). This is also identified as “healing” the crack in a metallic substrate. An advantage of a healing is that the small transverse distances across the crack permit substantial diffusion, allowing the melting point depressants to diffuse out from the material within the crack and leaving highly near base metal composition. For typical nickel-base superalloys this results in an isothermally solidified structure whose mechanical properties are near that of the base metal.

For larger defects (e.g. large chips, wear areas, or contaminated cracks requiring routing out to provide a clean base metal surface) a “build-up” repair is required (e.g., wherein portions of the repair material are more than about 1 mm from the nearest base metal of the substrate). In many cases, a common alloy mixture may be used for both crack and build-up repairs although specifically designed “preforms” (i.e., prostheses) may be developed for a recurrent build-up repair. For build-up repairs, usually only a partial isothermal structure is achieved due to limitations in diffusion time relative to the required diffusion distances. As such, the build-up repair will have a coarse, more globular, type of microstructure while the crack repair will tend to look much like the base alloy with a defined grain structure.

For parts having cooling passageways, various techniques have been proposed for preserving those passageways when the passageways intersect the damage or wear site. U.S. Pat. No. 6,742,698 discloses a refractory metal insert used with welding repairs along a trailing edge region of an airfoil. U.S. Pat. No. 5,935,718 discloses inserts used in brazing and solder repairs.

### SUMMARY OF THE INVENTION

Accordingly, one aspect of the invention involves a method for forming or remanufacturing a component to have an internal space. A refractory metal blocking element is positioned with at least a portion to be within the internal space. A material is added by at least one of laser cladding and diffusion brazing, the blocking element at least partially blocking entry of the material to the internal space. The blocking element is removed.

In various implementations, the portion may comprise a first portion inserted within a pre existing portion of the internal space and a second portion. The blocking element may be essentially an uncoated single refractory metal. The blocking element may be essentially a single refractory metal with a ceramic coating. The component may have previously lacked said internal space. The adding may comprise diffusion brazing using a powdered material comprising a mixture of first and second component powders, the second powder being a majority, by weight, of the powdered material and the first powder acting as a melting point depressant for the second powder. The first powder component may include in its composition a quantity of a melting point depressant substantially in excess of that in the second powder. The first and second component powders may be present in a mass ratio of between 1:10 and 1:2. The first component powder may have at least 2.5% boron and the second component powder may have less than 0.5% boron. The first component powder may have at least 2% boron and the second component powder may have less than 1% boron. The first and second component powders may be nickel based. The internal space may extend to a damage site from which the component has lost first material. The method may further comprise removing additional material at least partially from the damage site to create a base surface. The adding of the material may add the material atop the base surface at least partially in place of the first material and the additional material. The material may in major part replace said first material. The blocking element may have a first surface portion having a shape effective to re form an internal surface portion of the component bounding the internal space. The placing may cause the first surface portion to at least partially protrude from an intact portion of the component. The adding of the material may include adding the material atop the first surface portion. The component may be an internally-cooled gas turbine engine turbine section element. The material may be selected from the group consisting of Ni- or Co-based superalloys. The component may comprise a substrate material selected from the group consisting of Ni- or Co-based superalloys. The component may be a blade having an airfoil and the material may be added along a tip of the airfoil. The component may be a blade or vane having an airfoil and the material may be added along a trailing edge of the airfoil. The material may be added to a depth of at least 2.0 mm. The method may further comprise machining the material to restore an external contour of the airfoil. The positioning of the blocking element may comprise trimming a pre formed insert. The removing may comprise at least one of chemically removing and mechanically removing removing may comprise pulling. The method may be a portion of a reengineering and remanufacturing process wherein the component has been in service without said internal space and said internal space functions to increase resistance to thermal-mechanical fatigue.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a turbine blade of a gas turbine engine.

FIG. 2 is a chordwise sectional view of the airfoil of the blade of FIG. 1.

FIG. 3 is a median sectional view of a tip portion of the airfoil of the blade of FIG. 1.

FIG. 4 is an enlarged view of a portion of the airfoil of FIG. 3 upon damage.

FIG. 5 is a view of the airfoil of FIG. 4 during remanufacture.

FIG. 6 is an enlarged view of a portion of the airfoil of FIG. 3 upon damage.

FIG. 7 is a view of the airfoil of FIG. 6 during remanufacture.

FIG. 8 is a view of the airfoil of FIG. 6 after remanufacture.

FIGS. 9 and 10 respectively are streamwise and spanwise sectional photomicrographs of a trailing edge repair after leaching out of an insert.

FIG. 11 is a streamwise sectional photomicrograph of a trailing edge repair before atop an insert.

FIG. 12 is an enlarged view of the photomicrograph of FIG. 11.

FIG. 13 is a streamwise sectional photomicrograph of a trailing edge repair after removal of an insert.

FIG. 14 is an enlarged view of the photomicrograph of FIG. 13.

Like reference numbers and designations in the various drawings indicate like elements.

### DETAILED DESCRIPTION

FIG. 1 shows a turbine element (e.g., a gas turbine engine turbine blade 22). The exemplary blade 22 includes an airfoil 24 extending from a root 26 at a platform 28 to a tip 30. The airfoil has leading and trailing edges 32 and 34 separating pressure and suction sides 36 and 38. The platform 28 has an outboard portion 40 for forming an inboard boundary/wall of a core flowpath through the turbine engine. A mounting portion or blade root 42 depends centrally from the underside of the platform 28 for fixing the blade in a disk of the turbine engine. Optionally, all or some portion (e.g., the platform 28 and airfoil 24) may be coated. A cooling passageway network (not shown in FIG. 1) may extend through the blade from one or more inlets in the root to multiple outlets along the blade sides, edges, tip, and/or root. Exemplary blades may be made from nickel- or cobalt-based superalloys.

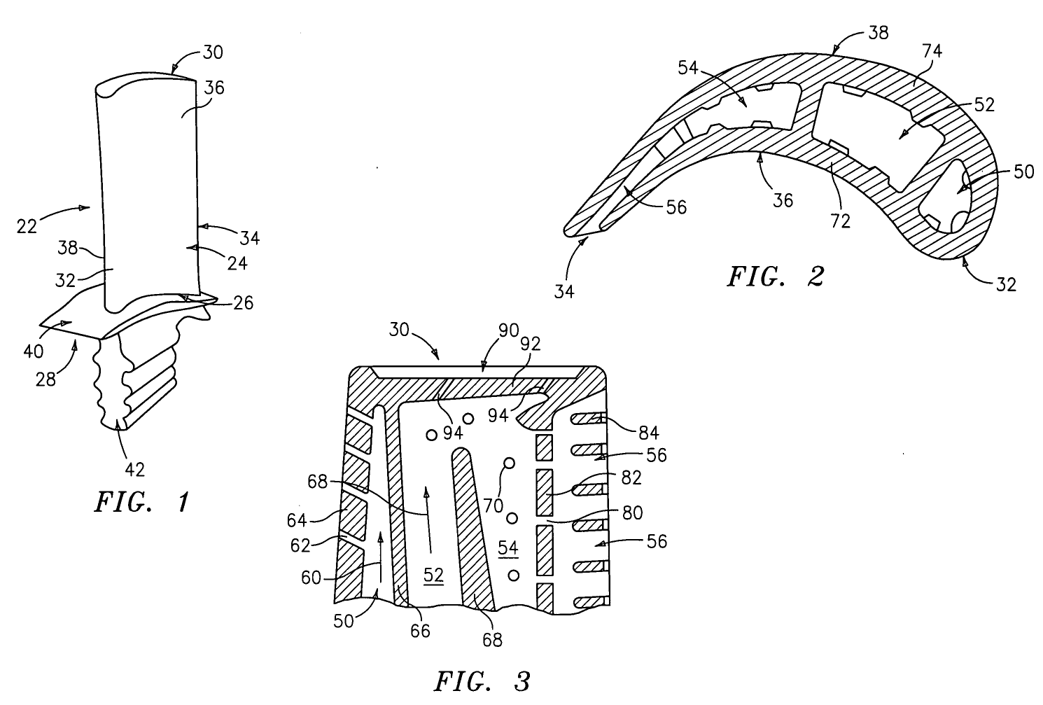

FIG. 2 shows portions of the cooling passageway network. The illustrated blade and network are illustrative. Those skilled in the art will recognize that other component envelope and passageway configurations are possible. The network includes a leading passageway or cavity 50, a second cavity 52 aft thereof, a third cavity 54 aft thereof, and a fourth cavity or trailing edge slot 56 yet further aft. FIG. 3 shows an implementation wherein the leading cavity 50 directs a cooling flow 60 from inboard to outboard and incrementally exiting through a spanwise series of leading edge cooling outlet passageways 62 in a leading edge wall portion 64. The second cavity 52 is separated from the leading cavity 50 by a wall portion 66. The exemplary second and third cavities are legs of a single passageway separated by a wall portion 68, with the second cavity 52 carrying a flow 68 in an outboard direction and the third cavity 54 returning the flow in an inboard direction. The second and third cavities may contain pedestal stubs 70 or other surface enhancements extending from pressure and suction side surfaces of respective pressure and suction side wall portions 72 and 74 (FIG. 2). Alternatively or additionally, pedestals (not shown) may extend between the sides. The inboard flow through the third cavity 54 incrementally exits aft through apertures 80 in a wall 82 dividing the third cavity from the slot 56. The slot 56 extends to the trailing edge and has a number of walls 84 extending between pressure and suction side surfaces of the respective pressure and suction side wall portions. In the exemplary embodiment, the tip 30 has a tip cavity or pocket 90 separated from the internal cavities by a wall 92 and having outlet passageways 94 therein for venting air from the flow 68.

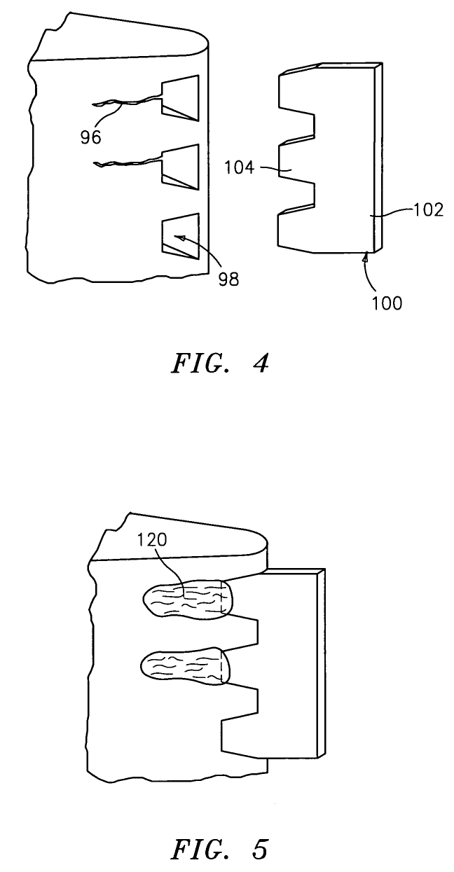

FIG. 4 shows localized damage such as cracks 96 resulting from thermal-mechanical fatigue. The exemplary cracks 96 are located in the pressure side wall 72 and extend forward/upstream from outlets 98 of the slot 56 between associated pairs of the walls 84. In addition or alternative to the TMF cracking, the airfoil may be subject to foreign object damage (FOD) and more general damage such as wear, erosion, oxidation, or creep or may have a manufacturing defect. Even when the damage itself does not penetrate the interior of the airfoil, the penetration may be close enough to the cavity that repair attempts may penetrate the cavity. For example, it may be desired to clean the damaged surfaces prior to repair. If the cleaning involves machining, that machining may penetrate the cavity.

According to the invention, an additional material may be applied in association with a cavity, passageway, or other part internal space. A preferred diffusion braze involves use of a transient liquid phase (TLP) forming process such as disclosed in U.S. Pat. No. 4,008,844, the disclosure of which is incorporated by reference herein as if set forth at length. In this process, powders of multiple alloys are provided either pre-mixed or mixed by the application apparatus. The component powders may be selected in view of the workpiece properties. The exemplary powder material TLP-forming powder and a main powder. The exemplary main powder may have a composition similar to the desired deposit. The TLP powder may have an otherwise generally similar composition but including at least one melting point depressant such as boron.

The workpiece may consist of or comprise a nickel- or cobalt-based superalloy substrate (e.g., such a substrate may have a protective coating). The apparatus may be used to form a deposit for replacing material lost from the substrate (e.g., due to damage plus cleaning and preparation) or to augment (e.g., fill a manufacturing defect, coat with a dissimilar material, or otherwise).

Prior to material application, the site may be cleaned of contamination. Protective coatings may be locally or globally removed or left in place. Coating removal may be by grit blast (e.g., for ceramic barrier coatings) or by exposure to liquid acids (e.g., a hydrochloric/nitric acid solution for removal of metallic coatings). Additional steps such as vacuum cleaning, or fluoride ion cleaning may be employed to remove tenacious oxides formed during engine operation. When oxidation products extend into deep cracks, fluoride cleaning as is most appropriate. Corrosive products may also be removed by chemical means or by grit blast.

To form the missing interior surface of the airfoil along the cracks 96 and to prevent infiltration of the additional material into the slot 56, a backing element 100 is used. The exemplary backing element is formed of a refractory metal (e.g., selected from the group consisting of niobium, tantalum, molybdenum, tungsten, and alloys/combinations thereof). As is discussed below, depending upon circumstances the backing element may have a coating (e.g., a ceramic coating such as alumina) to prevent diffusion or chemical reactions between the backing element and the repair or may be uncoated to permit such diffusion or chemical reaction. The backing element may additionally or alternatively be plated with nickel to promote surface wetting when wetting characteristics are required for improved feature generation. For the exemplary trailing edge slot use, the element 100 is formed as a comb having a spine 102 and a plurality of tines 104. The tines are dimensioned to fit within an associated outlet 98 and have pressure and suction side surfaces positioned to fall along the interior surfaces of the and pressure and suction side walls 70 and 72. Lateral surfaces of the tines are configured to fall along lateral surfaces of the adjacent ribs 84.

After comb insertion, paste patches 120 of the repair material are applied over the cracks 96 and may overlap adjacent portions of the comb 100. An exemplary viscous paste is formed by combining the alloy powders and a suitable volatile binder which is flux free to avoid contamination. The binder is capable of being burned off without leaving an undesirable residue when the paste is heated. Advantageously, the binder burns off well before melting of the TLP material begins (e.g., burns off at or below 1000° F.). For larger cracks or for channels routed out to remove cracks, the patches may fill the open area atop the comb tines within the crack or routed channel. An exemplary binder is NICROBRAZ S binder from Wall Colmonoy Corporation, Madison Heights, Mich.

To initiate the bonding, the pasted airfoil is heated. In an exemplary processing cycle, the component and paste are heated in a suitable protective atmosphere (e.g., inert gas, vacuum, or other gas not adversely interacting with the process). An exemplary temperature is about 2200° F. (e.g., 2150-2275° F.). An exemplary duration of this heating is 5-24 hours (e.g., about ten hours). Following this heating the component may be rapidly cooled. In a second exemplary processing cycle, the component and paste are heated in a suitable protective atmosphere to a greater temperature for a much shorter duration. An exemplary temperature is about 2300° F. (e.g., 2250-2350° F.). An exemplary duration of this heating less than about thirty minutes, preferably fifteen minutes or less and is followed by rapid cooling.

The comb may then be removed by leaching. The exterior contour of the airfoil may be restored by machining the exterior of the patch material formed from the patches 120. The component may then be subjected to an aging heat treatment. A coating may be applied (either overall or locally atop the machined patch areas if coating is elsewhere intact).

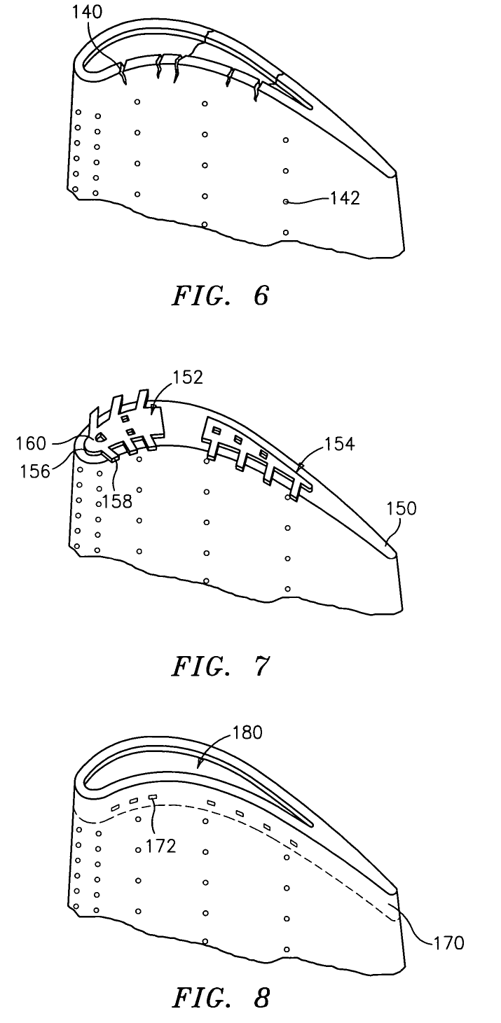

FIG. 6 shows damage to the tip area of the blade of FIG. 1. In the exemplary damage, TMF cracks 140 have formed along the pressure side wall 72 at the tip 30. Analysis of the cracks may show that improved cooling is appropriate. For example, existing cooling holes/passageways 142 may not provide the most advantageous cooling. It may thus be desirable to remanufacture the blade with improved cooling not previously present by remanufacturing the blade in accordance by the present methods. For example, the shape, size, distribution or the like of the holes/passageways may be altered. Additional holes or passageways may be provided.

A tip portion of the blade may be removed by machining to leave a cut surface 150 (FIG. 7). One or more backing elements 152 and 154 may be applied over the cut surface 150. The exemplary elements 152 and 154 each have a central main body 156 from which a plurality fingers 158 extend. The elements 152 and 154 also include apertures 160. Material 170 (FIG. 8) may be built up over the backing elements 152 and 154 to form a replacement tip region. An exemplary build-up is performed by laser cladding. After leaching out the backing elements 152 and 154 and any further machining (e.g., to provide the final airfoil contour), the replacement tip region includes cooling passageways/holes left by the fingers 158. In some implementations, the bodies 156 may leave plenums to feed the cooling passageways. In such plenums, the holes 160 may leave posts connecting/retaining an outboard portion of the replacement tip to the base metal at the cut surface 150. The plenums may be fed by holes extending into one or more of the pre-existing internal cavities 50, 52, and 54 (e.g., pre-drilled through the surface 150). A tip cavity 180 (e.g., like 90) may be machined in the replacement tip and feed holes drilled into the plenum (if any) or the pre-existing internal cavities.

### Example 1

A trailing edge repair was carried out on a plurality of vane airfoils formed of PWA 1484 superalloy (nominal composition in weight percent: 5 Cr, 5.6 Al, 9 Ta, 6 W, 3 Re, 2 Mo, 10 Co, 0.1 Hf, balance Ni and more broadly identified in U.S. Pat. No. 6,503,349). A cut-off wheel was used to machine a streamwise gap through the trailing edge to simulate the gap where similar machining removes a cracked area. Alumina-coated molybdenum combs were used. A powder mix consisting of 60% PWA 1484 and 40% PWA 36117-1 TLP or low melt alloy (e.g., as disclosed in at the last paragraph of the third column of U.S. Pat. No. 6,503,349). All percentages are weight percentages unless identified to the contrary. The vane airfoil and repair alloy were heated in a protective atmosphere to a temperature of about 2225° F., for a time period of about ten hours. Following heating, the component was rapidly cooled. The repair alloy was observed to flow and wet the surface of the component indicating that the repair alloy filled the repair gaps.

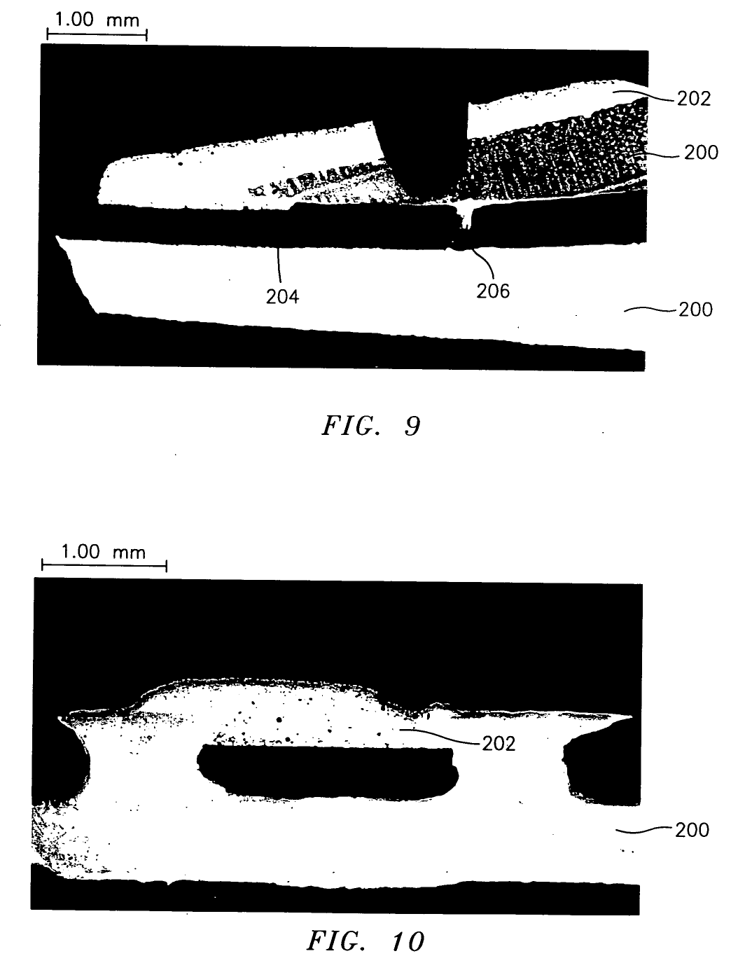

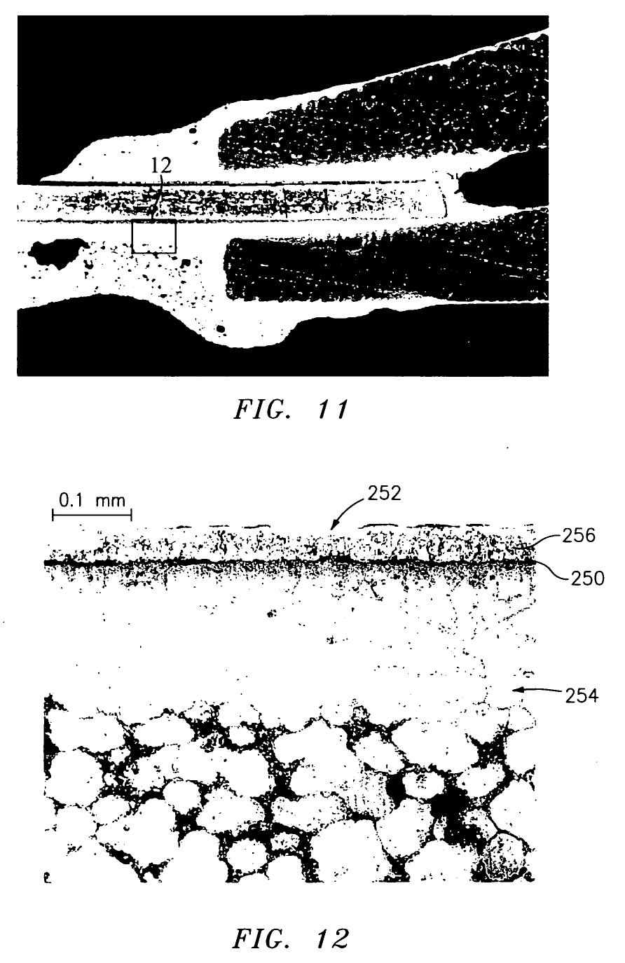

The vane repair areas were metallographically sectioned in transverse (spanwise) and longitudinal (streamwise) directions, mounted, polished, and swab etched with AG 21 etchant (a mixed acid solution containing lactic, nitric, and hydrofluoric acids) to reveal the microstructures of the base metal substrate 200 and the applied material 202. The sections were examined with optical microscopy. FIGS. 9 and 10 show streamwise and spanwise sections after leaching out of the comb and etching (an erroneous spanwise cut in the FIG. 9 streamwise section suction side should be ignored). The observed microstructure of the material 202 is consistent with typical nickel TURBOFIX TLP build-up repairs. Athermal, eutectic phases are evidenced throughout the material. A partially isothermal solidification microstructure is present throughout the material 202.

The geometry of the exit slot was 204 well maintained by the insert/comb. The fit-up of the insert appears critical for the reproduction of internal features. The size of the cooling passage or internal feature is dependent upon the initial insert fit. In this example, a slightly undersized insert resulted in a reduction in the slot width in the repaired slot. It was also observed that the molten TURBOFIX alloy flowed and flashed over the inner edge of the molybdenum comb to create a flash area 206. In a production environment, if improved insert fit does not completely prevent flashing, the addition of a conventional internal stop-off may be used to prevent this flashing and avoid a need to machine out/off the flash. With the coated insert, adhesion between the insert and the material is limited. It was observed that, if the insert shape avoided interlocking (e.g., by appropriate tapering), the insert could be pulled out after the repair so as to avoid the need to chemically leach out the insert. Physical (mechanical) removal allows one to avoid the chemical leaching operation. Chemical leaching typically involves immersion of the repaired component in a mixed acid solution (e.g., aqueous nitric/sulfuric acid solution). With physical removal, the leaching step may be avoided. This results in time savings, in reduced equipment requirements, and in waste reduction (waste acids). The ceramic coating, may inhibit wetting of the insert (e.g., relative to wetting of nickel-plated or uncoated inserts). The relatively non-wetting ceramic coating may thus be appropriate to limit wicking of a molten alloy (e.g., the braze material) into the internal cavity. Where wetting is desired, an uncoated or plated insert could be preferred.

### Example 2

A similar trailing edge repair was carried out using uncoated molybdenum combs. Heating parameters were the same as Example 1. The repair alloy was observed to flow and wet the surface of the component indicating that the repair alloy filled the repair gaps. To the eye, no difference was noted in the interaction between the molten repair alloy and the uncoated comb relative to the coated comb. Microstructural evaluation reveal some significant microstructural differences described below.

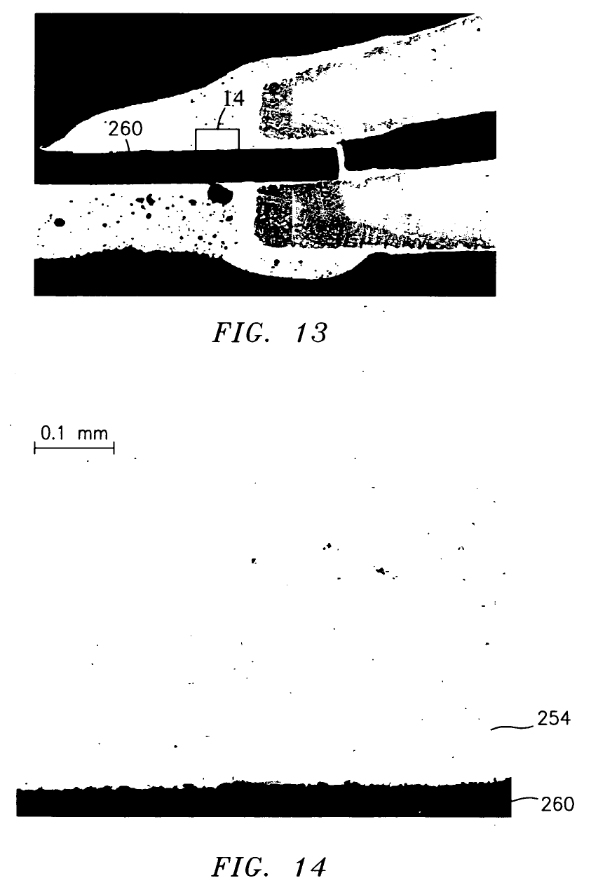

FIG. 11 shows a cross-section of the repair before comb removal. FIG. 12 shows the interface 250 between the comb 252 and repair material 254. The comb 252 reacted with the material 254 to form a diffusion zone 256 along the interface within the comb. Quantitative electron microprobe analysis determined that the diffusion zone 256 is composed mainly of 17% nickel and 60% molybdenum. Boron was also present in the diffusion zone 256. A quantitative assessment of the boron level was not practical due to interference from the molybdenum signature relative to the boron signature. Because the diffusion zone 256 was primarily composed of molybdenum, the chemical leaching process was successful in completely removing this layer along with the pure molybdenum comb 252. Microprobe analysis also found that the material 254 had an average composition close to the original substrate chemistry.

FIGS. 13 and 14 show a cross-section of the repair after comb removal by chemical leaching to leave a slot 260. An observation that may be made when comparing FIGS. 9 and 10 on the one hand and FIGS. 13 and 14, on the other hand, is that the zone of repair material 254 adjacent to the uncoated comb 252 appears to exhibit a microstructure that is more similar to a TURBOFIX TLP crack repair (full isothermal solidification) while the material 202 adjacent to the alumina-coated comb appears more like a TURBOFIX TLP build-up repair. In the fully isothermal solidification structure, a defined grain structure similar to the base metal is observed. However, in regions of partial isothermal solidification, sub-regions rich in boron are observed between globular phases composed mainly of the base alloy constituents. This athermal microstructure may tend to result from limitations in diffusion due to time, temperature, and the availability of a diffusion path for boron. Structurally, a fully isothermal structure will achieve near base metal strength levels while athermal structures will be brittle and low in strength compared to the base metal. The material 202 adjacent to the alumina-coated comb appears to inhibit/block boron diffusion into the molybdenum while the uncoated comb acts as a sink for excess boron. The result of the boron sink is an improved build-up microstructure adjacent to the uncoated comb.

One or more embodiments of the present invention have been described. Nevertheless, it will be understood that various modifications may be made without departing from the spirit and scope of the invention. For example, although particularly useful with turbine blades and vanes, the methods may be applied to other blades and other turbine engine parts and non-turbine parts. Details of the particular turbine engine part or other piece and the particular wear or damage suffered or susceptible to may influence details of any given restoration. Accordingly, other embodiments are within the scope of the following claims.

What is claimed is:

1. A method for forming or remanufacturing a component to have an internal space comprising;
positioning a refractory metal blocking element with at least a portion to be within the internal space;
adding a material by at least one of laser cladding and diffusion brazing, the blocking element at least partially blocking entry of the material to the internal space; and
removing the blocking element.

2. The method of claim 1 wherein:
the portion comprises a first portion inserted within a pre-existing portion of the internal space and a second portion.

3. The method of claim 1 wherein:
the blocking element is essentially an uncoated single refractory metal.

4. The method of claim 1 wherein:
the blocking element is essentially a single refractory metal with at least one of a ceramic coating and a nickel plating.

5. The method of claim 1 wherein:
the component had previously lacked said internal space.

6. The method of claim 1 wherein:
the adding comprises diffusion brazing using a powdered material comprising a mixture of first and second component powders, the second powder being a majority, by weight, of the powdered material and the first powder acting as a melting point depressant for the second powder.

7. The method of claim 6 wherein:
the first powder component includes in its composition a quantity of a melting point depressant substantially in excess of that in the second powder.

8. The method of claim 6 wherein:
the first and second component powders are present in a mass ratio of between 1:10 and 1:2.

9. The method of claim 6 wherein:
the first component powder has at least 2.5% boron; and
the second component powder has less than 0.5% boron.

10. The method of claim 6 wherein:
the first component powder has at least 2% boron; and
the second component powder has less than 1% boron.

11. The method of claim 6 wherein:
the first and second component powders are nickel or cobalt based.

12. The method of claim 1 wherein:
the internal space extends to a damage site from which the component has lost first material.

13. The method of claim 12 wherein:
the method further comprises removing additional material at least partially from the damage site to create a base surface; and
the adding of the material adds the material atop the base surface at least partially in place of the first material and the additional material.

14. The method of claim 12 wherein:
said material in major part replaces said first material.

15. The method of claim 1 wherein:
the blocking element has a first surface portion having a shape effective to re-form an internal surface portion of the component bounding the internal space;
the placing causes the first surface portion to at least partially protrude from an intact portion of the component; and
the adding of the material includes adding the material atop the first surface portion.

16. The method of claim 1 wherein:
the component is an internally-cooled gas turbine engine turbine section element.

17. The method of claim 1 wherein said material is selected from the group consisting of Ni- or Co-based superalloys.

18. The method of claim 1 wherein said component comprises a substrate material selected from the group consisting of Ni- or Co-based superalloys.

19. The method of claim 1 wherein the component is a blade having an airfoil and the material is added along a tip of the airfoil.

20. The method of claim 1 wherein the component is a blade having an airfoil and the material is added along a trailing edge of the airfoil.

21. The method of claim 1 wherein the material is added to a depth of at least 2.0 mm.

22. The method of claim 1 further comprising:
machining the material to restore an external contour of the airfoil.

23. The method of claim 1 wherein the positioning of the blocking element comprises trimming a pre-formed insert.

24. The method of claim 1 wherein the removing comprises at least one of chemically removing and mechanically removing.

25. The method of claim 1 wherein the removing comprises pulling.

26. The method of claim 1 being a portion of a reengineering and remanufacturing process wherein the component has been in service without said internal space and said internal space functions to increase resistance to at least one of thermal-mechanical fatigue, creep, and oxidation.

27. Use of a sacrificial refractory metal body as a sink for a melting point depressant in a diffusion repair.
